(19) United States
(12) Patent Application Publication
(10) Pub. No.: US 2008/0147880 A1
(43) Pub. Date: Jun. 19, 2008

(54) Methods And Systems For Routing A Message Over A Network

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/610,917

(22) Filed: Dec. 14, 2006

(51) Int. Cl. G06F 15/173

(52) U.S. Cl. 709/238

(57) ABSTRACT

Methods and systems are described for routing a message over a network. An exemplary method includes establishing relationships among a plurality of network appliances using respective network appliance class identifiers assigned to the appliances. The respective network appliance class identifiers are assigned to identify corresponding classes of network appliances prior to their operation within the network environment. A message is received over the network from a sending network appliance. The message includes a particular network appliance class identifier. Using the established relationships, a target network appliance, operable within the network, is determined belonging to a class of network appliances related to the particular network appliance class identifier. The received message is routed to the target network appliance via the network.

### RELATED APPLICATIONS

The subject matter of this application is related to U.S. patent application Ser. No. 11/555,248, titled “METHOD AND SYSTEM FOR ROUTING A MESSAGE OVER A HOME NETWORK” (Attorney Docket No. I407/US), filed on Oct. 31, 2006, and U.S. patent application Ser. No. 11/______, titled “METHOD AND SYSTEM FOR SYNCHRONIZING OPERATING MODES OF NETWORKED APPLIANCES” (Attorney Docket No. I439/US), filed on even date with this application, each of these related applications being commonly owned by the owner of this application, the entire disclosures of which are each here incorporated by reference.

### BACKGROUND

Electronic computing is becoming more and more ubiquitous. Not only do desktop computers, laptops, and handheld computing devices have processors, but most audio/video equipment, appliances, automobiles, etc., have one or more processors as well. Many of these devices have no display, or provide a display on the device that is small. Few devices provide remote user interfaces. Integrating all this computing power has been a problem of interest for some time. For example, a common home includes a television, a digital video recorder (DVR), a desktop computer, multiple kitchen appliances, a refrigerator, and a washer and dryer. Each of these devices can be networked and each includes a processor.

However, these devices do not communicate for the most part. In the above system, there is no way for the refrigerator to communicate with the television. Further, today's systems lack a dominating standard for communicating. Each of the proposed standards has its own complexities that make interoperability a problem.

Accordingly, there exists a need for methods, systems, and computer program products for routing a message over a network.

### SUMMARY

In one aspect of the subject matter disclosed here, a method for routing a message over a network is described. The exemplary method includes establishing relationships among a plurality of network appliances using respective network appliance class identifiers assigned to the appliances. The respective network appliance class identifiers are assigned to identify corresponding classes of network appliances prior to their operation within the network environment. A message is received over the network from a sending network appliance. The message includes a particular network appliance class identifier. Using the established relationships, a target network appliance, operable within the network, is determined belonging to a class of network appliances related to the particular network appliance class identifier. The received message is routed to the target network appliance via the network.

In another aspect of the subject matter disclosed here, a system for routing a message over a network is described. The exemplary system includes a relationship manager configured to establish relationships among a plurality of network appliances using respective network appliance class identifiers assigned to the appliances. The respective network appliance class identifiers are assigned to identify corresponding classes of network appliances prior to their operation within the network environment. A message router is configured to receive a message over the network from a sending network appliance. The message includes a particular network appliance class identifier. A traversal engine is configured to determine, using the established relationships, a target network appliance operable within the network belonging to a class of network appliances related to the particular network appliance class identifier. The message router is configured to route the received message to the target network appliance via the network.

In yet another aspect of the disclosed subject matter, an exemplary method for routing a message over a network includes generating a message including a particular network appliance class identifier assigned to a sending network appliance prior to operation of the sending network appliance within the network environment. The generated message is processed using a set of relationships established among a plurality of network appliances, including the sending network appliance, to determine a target network appliance, operable within the network, belonging to a class of network appliances related to the particular network appliance class identifier included in the generated message and to route the message to the target network appliance via the network. The set of relationships is established using respective network appliance class identifiers assigned to the network appliances to identify corresponding classes of network appliances prior to their operation within the network environment.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating an exemplary method for routing a message over a network, according to an exemplary embodiment;

FIG. 2 illustrates an exemplary system for routing a message over a network, according to an exemplary embodiment;

FIG. 3 provides a detailed illustration of a relationship router shown in FIG. 2, according to an exemplary embodiment;

FIG. 4 is a message flow diagram illustrating an exemplary message flow in routing a message over a network using the arrangements shown in FIGS. 2 and 3, according to an exemplary embodiment;

FIGS. 5A-5D illustrate alternate exemplary embodiments of systems for routing a message over a network;

FIG. 6 is a message flow diagram illustrating an exemplary message flow in routing a message over a network using the various embodiments depicted in FIGS. 5A-5D, according to an exemplary embodiment; and

FIGS. 7-9 illustrate alternative exemplary embodiments of message flows suitable for routing a message over a network.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

As used here, a “relationship” is an association between or among a plurality of network appliances. A relationship may be predefined by a manufacturer, reseller, and/or installer, for example, including an owner or other user of a network appliance. A relationship may be defined dynamically as network appliances register themselves and optionally register class records needed by the network appliance. In its most basic embodiment, a relationship is simply a link from one record or tuple to another record or tuple. Relationships may be unidirectional or bidirectional. Relationships may be typed or categorized with each type or category associated with information specific to the type or category. Relationships may have cardinality constraints including support for one-to-one, one-to-many, many-to-many, and/or m-to-n relationships where ‘m’ and ‘n’ are configurable for any given relationship or type of relationship. Some embodiments may support additional data associated with a relationship, such as typed relationships previously mentioned. The associated data may include information used by a traversal engine described later in filtering paths to traverse, saving the cost of traversing all paths in search of a best match.

As used here, a “service” is a role played by a network appliance, executable, and/or other resource coupled to a network, which receives a message and provides a function, fulfills a request, or processes a command based on the message.

As used here, a “class” is a type or category associated with a network appliance via a corresponding class identifier. For example, a non-exhaustive list of class types include a class assigned to represent a network appliance's general function or service, an application or service hosted by a network appliance, a network appliance's location, an output type of a network appliance, and input type of a network appliance, a service usable by a network appliance, an operational mode of a network appliance, or a user or user role associated with a network appliance.

Network appliance classes may be defined that include multiple aspects from, for example, the previous non-exhaustive list of class types, thus creating combination classes, each associated with the particular class identifiers of classes that form the combination. A network appliance may be associated with zero or more classes. According to the embodiments described herein, class identifiers are assigned to identify corresponding classes of network appliances prior to their operation within the network environment. For example, classes of network appliances may be predefined by a manufacturer, reseller, and/or installer, including an owner or other user of a network appliance, and corresponding class identifiers assigned prior to their operation within the network environment.

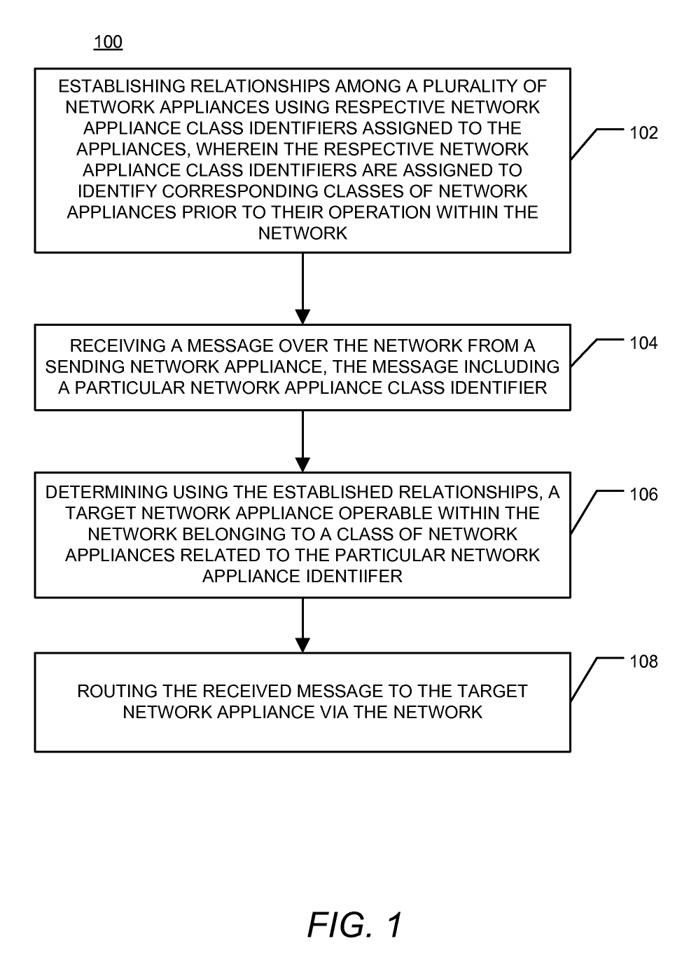

According to one aspect, the subject matter described here includes a system and method for routing a message over a network. FIG. 1 illustrates an exemplary method 100 for routing a message over a network. The method allows a sending network appliance to send a message to a target network appliance via the network without knowledge of either a network address of the target or a name of the specific target network appliance. The target network appliance is located using one or more established relationships specified between or among a set of network appliances having corresponding network appliance class identifiers assigned prior to their operation with the network environment.

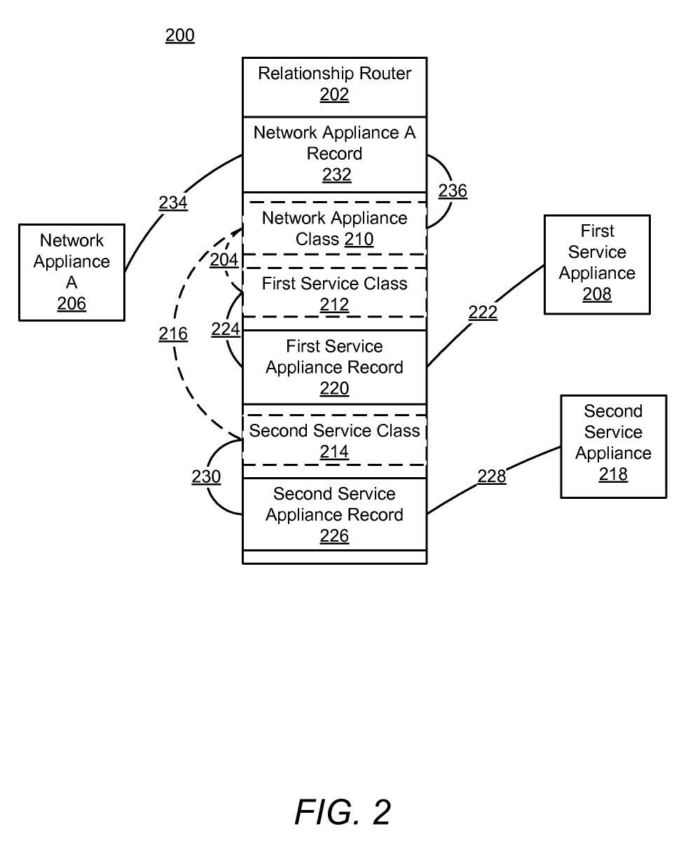

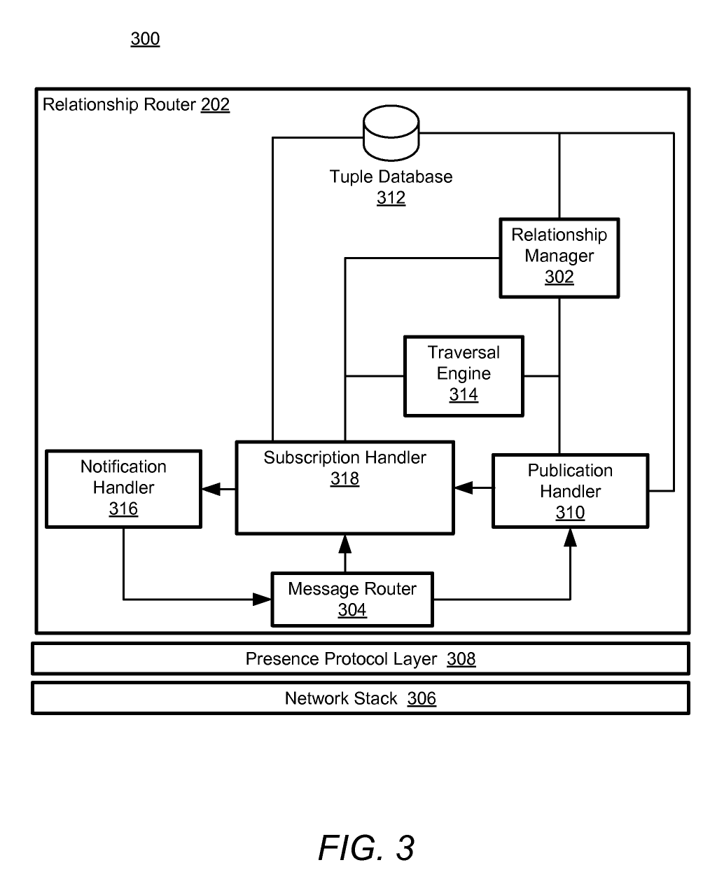

For example, FIG. 2 depicts an exemplary system 200 using a particular routing device or server referred to here as a relationship router 202 for performing the method 100 from a network-component-level view. The system 300 depicted in FIG. 3 illustrates a detailed exemplary embodiment of a relationship router 202 based upon a real-time, publish-subscribe server, of which a presence server is but one embodiment. The relationship router 202 manages relationships among and between networked appliances. While depicted as a separate, centralized server in the figures, persons skilled in the art will understand that the functionality of the relationship router 202 for managing relationships among and between networked appliances can be integrated into one or more of the appliances, such as a sending or target network appliance between which a message is being routed. Thus, both centralized and peer-to-peer messaging arrangements are within the scope of the subject matter described here.

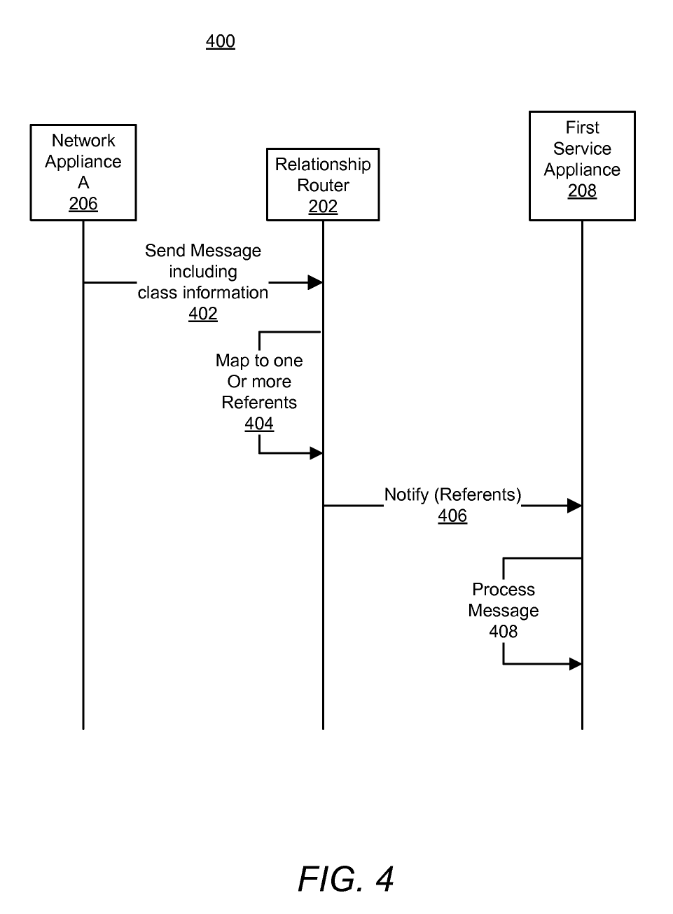

FIG. 4 depicts a message flow diagram 400 illustrating an exemplary message flow among the networked components of the system 200. An embodiment of the method 100 in FIG. 1 is described here in terms of the systems 200 and 300, and the message flow diagram 400 in FIG. 2, FIG. 3, and FIG. 4, respectively.

At block 102 of the method 100, relationships are established among a plurality of network appliances. The relationships are established using respective network appliance class identifiers. As described in conjunction with the definition of a “class” of network appliances above, the respective network appliance class identifiers are assigned to identify corresponding classes of the network appliances prior to their operation within the network.

As described above, a network appliance, can be assigned a class identifier based on an attribute of the network appliance such as role mode, function, data output, data input, and/or a service requirement. For example, a digital video recorder (DVR), in an embodiment, can be assigned a class identifier corresponding to media players. This class identifier identifies the DVR and its capabilities as a potential service for network appliances having a compatible media source. At the same time, the “media player” class identifier can identify the DVR as a potential client of a television (TV) assigned a class identifier corresponding to display devices.

Class identifiers can vary in specificity depending on the embodiment. For example, in another embodiment, the DVR of the previous example can be assigned the class identifier corresponding to display devices allowing the DVR to locate a display device when needed using the class identifier corresponding to display devices. In yet another embodiment, the TV can be assigned a class identifier corresponding to media players allowing the TV to communicate with a media player that requires the services of the TV in the manner provided by the exemplary systems, methods, and program products described here.

An exemplary system for performing the method 100 of routing a message over a network is depicted in FIG. 2. The system includes means for establishing relationships among a plurality of network appliances using respective network appliance class identifiers assigned to the appliances, wherein the respective network appliance class identifiers are assigned to identify corresponding classes of network appliances prior to their operation within the network environment. For example, the system 200 shown in FIG. 2 depicts a relationship router 202. The relationship router 202 (depicted in detail in FIG. 3 as the system 300) in one embodiment includes a relationship manager 302 configured to establish relationships among a plurality of network appliances. For example, a relationship 204 indirectly relates network appliance A 206 and first service 208 using respective network appliance class identifiers, such as a “network appliance” class identifier, represented by a network appliance class record 210, and a “first service” class identifier, represented by a first service class 212 record, in the relationship router 202. The respective network class identifiers are assigned to identify corresponding classes of network appliances prior to their operation within the network environment.

In the depicted embodiment, at least a portion of the records in the relationship router 202 associated with class identifiers are pre-associated (or preconfigured) in the relationship router 202 by, for example, a manufacturer, reseller, or installer of the relationship router 202. In the embodiment, the network appliance class identifier record 210 includes service information identifying one or more service classes that may be of use to a network appliance corresponding to the “network appliance” class identifier, such as the network appliance A 206, indirectly assigned to the “network appliance” class identifier as will be described. Also established prior to operation in the relationship router 202, in the depicted embodiment, is a second service class record 214 representing a “second service” class identifier and a relationship 216 between the network appliance class record 210 and the second service class record 214.

In the example embodiment, pre-established relationships and records are illustrated with broken lines and borders. The relationships indicate that network appliances corresponding to the “network appliance” class identifier use other network appliances providing a service corresponding to the “first service” class identifier and/or a service corresponding to the “second service” class identifier. As previously stated, relationships based on possible service use by an appliance is one type of relationship that may be used and established prior to operation of corresponding network appliances for the purpose of routing messages among network appliances. Thus, according to this embodiment, not only are the class identifiers assigned to corresponding network appliances prior to their operation within the network environment, but the relationships among network appliances are preconfigured in the relationship router 202 using these identifiers prior to operation of the relationship router 202 itself within the environment.

Also depicted in the system 200 is a provider of a second service 218. The network appliance A 206, the first service appliance 208, and the second service appliance 218 are all communicatively coupled to a network (not shown) as is the relationship router 202. As discussed above, a service is an attribute of a network appliance and is provided, for example, by the network appliance hardware and/or software that receives a message and provides a function, fulfills a request, or processes a command based on the message. The first service appliance 208, in one embodiment, locates the relationship router 202 when the first service appliance 208 connects to the network. The relationship router 202 is located by the first service appliance 208 in a manner supported by the specific embodiment. For example, relationship router 202 can be located via a service record in a domain name system (DNS) server (not shown), by listening for a broadcast message over the network from the relationship router 202, and/or by having the address of the relationship router 202 provided by a dynamic host configuration protocol (DHCP) server (not shown) in response to the first service appliance 208 requesting the network address.

Once the relationship router 202 is located, the first service appliance 208 registers with the relationship router 202. The registration information can include service information. The service information includes a class identifier assigned to the first service appliance 208 prior to operation of the appliance 208 within the network environment, for example during manufacturing, installation, or sale of the first service appliance 208. A use of the class identifier, in the embodiment, is to identify a service, e.g., the first service represented by the first service appliance class record 214, provided by the first service appliance 208. In another embodiment, the first service appliance 208 service information includes a class identifier identifying a service that the first service appliance 208 requires or is capable of using, an input type such as content type it accepts, and/or a content type the first service appliance 208 provides as an output, for example. Some embodiments use only a single type of class identifier, for example, a network appliance type identifier, where the type corresponds to each of the corresponding network appliances' function, such as display, printer, network switch, firewall, refrigerator, and the like. Other embodiments use a plurality of class identifier types supporting a variety of relationship types.

The relationship router 202 stores the registration information for the first service appliance 208 in a record, a first service appliance record 220. The existence of the first service appliance record 220 establishes a relationship 222 between the first service appliance record 220 and the first service appliance 208. In one embodiment, the relationship router 202 uses the service information in the first service class record 212 with the service information in the first service appliance record 220. If the relationship router 202 determines a match exists, the relationship router 202 automatically establishes a relationship 224 between the first service appliance class record 212 and the first service appliance record 220. In an alternate embodiment, a user manually configures the relationships between the records. Accordingly, in these embodiments, the relationships among the plurality of network appliances can be established in the relationship router 220 insitu, rather than being preconfigured into the relationship router 220 prior to its operation in the network environment, as described in the alternative embodiment above.

The second service appliance 218 is registered similarly, resulting in the creation of a second service appliance record 226 and a relationship 228 between the second service appliance 218 and the second service appliance record 226. If the relationship router 202 determines a match exists between the service information of the second service appliance record 226 and the service information of the second service appliance class record 214, a relationship 230 between the two records is established by the relationship manager 302.

In the exemplary embodiment, when a network appliance registers with the relationship router 202, the relationship router 202 uses the registration information in the network appliance's record to locate one or more class records corresponding to the class identifiers that match. When a match is found, a relationship is established between the network appliance record and the service class record.

The network appliance A 206 registers with the relationship router 202 as previously described. Network appliance A's 206 registration causes relationship router 202 to create a record including information associated with network appliance A 206 shown as network appliance A record 232. The existence of network appliance A record 232 establishes a relationship 234 between network appliance A 206 and network appliance A record 232. In the embodiment described, the registration information in network appliance A record 232 includes a client identifier identifying that network appliance A 206 belongs to a “network appliance” class. The relationship router 202 uses the class information included in the registration information to locate one or more matching class records. In system 200, the relationship router 202 determines a match exists between the class information in network appliance A record 232 and network appliance class 210. As a result, the relationship router 202 establishes the relationship 236.

At block 104 of the method 100 depicted in FIG. 1, a message is received over the network from a sending network appliance. The message includes a particular pre-assigned network appliance class identifier. The system 200 of FIG. 2 includes means for receiving a message over the network from a sending network appliance, where the message includes a particular network appliance class identifier. For example, the relationship router 202 depicted in the system 200 and in greater detail in the system 300 includes a message router 304. The message router 304 is configured to receive a message over the network from a sending network appliance, such as network appliance A 206, where the message is sent to the relationship router 202. The message includes a particular network class identifier, such as the “network appliance” class identifier represented by the network appliance class record 210.

In the described embodiment, the message is addressed or associated with the network appliance A record 232 by including the record identifier in the message, or perhaps by the relationship router 202 using information in the record and the message to form the association. For example, an internet protocol (IP) address may be used in cases where the network appliance A 206 has a fixed network address. The established relationship 236 between the network appliance A record 232 and the network appliance class 210 is identified for use based on the “network appliance” class identifier included in the message and/or stored in the network appliance A record 232. In an embodiment, the “network appliance” class identifier is included in a uniform resource locator (URL) destination identifier for the message. In an embodiment, the “network appliance” class identifier is established by a token authority (not shown).

A token authority, for example, may be a network appliance manufacture, a service developer, an original equipment manufacture (OEM), a reseller, including a value added reseller (VAR), a network service provider, an installer or technical support engineer, or any other entity that has naming control over a portion of an identifier with a specified format on a particular network domain.

The receiving of the message is depicted in the message flow diagram 400 shown in FIG. 4 as a message 402 sent from network appliance A 206 to the relationship router 202. In an embodiment where the relationship router 202 supports a publish-subscribe protocol, such as a presence protocol, the message 402 would be a publish command (or message).

System 300 in FIG. 3 illustrates one particular embodiment of the relationship router 202 based on a presence service platform. The presence protocol described here includes terms defined by request for comments (RFC) 2778 to Day et al., titled “A Model for Presence and Instant Messaging,” published by The Internet Society (2000) the entirety of which is here incorporated by reference. In the described example, the message is received by a network stack 306 that processes and removes the various protocol headers and trailers of each protocol layer of the stack and routes the message to a presence protocol layer 308 based on a port number in the case where the network stack 306 is a TCP/IP stack. The presence protocol layer 308 of the embodiment further processes the message and passes the message to the message router 304 described earlier as being included in the relationship router 202.

In the example described, the network appliance A 206 in the system 200 is a presence client and the message includes a publish command. The message router 304 routes messages for processing based on a command type included in the message. In the case of a publish command, the message router 304 passes the message to a publication handler 310. The publication handler 310 using an identifier included in the message attempts to locate a tuple/record associated with the publisher, the network appliance A 206 in this example, in a tuple storage medium, such as a tuple database 312. The tuple database 312 of the described embodiment includes a variety of tuples. For example, tuples corresponding to the first service appliance record 220 and the network appliance A record 232 are stored in the tuple database 312. These tuples include presence information for principals (e.g., human and non-human entities that interact with a presence service) of the publishing network appliances. In an embodiment, the presence information stored in the corresponding tuple can be published to and/or subscribed to by an agent for a network appliance assigned a client identifier corresponding to the network appliance class of the network client A 206, and/or the first service appliance 208. A similar situation exists for the second service appliance 218.

In one embodiment, when no tuple is located for the received publish message, a tuple is created. The tuple, whether newly created or located, is associated with a presence entity (or presentity—a client of the presence service) sending the message, such as network appliance A's 206 presentity (not shown). When created, the tuple is created based on information included in the message including the publish command. If a tuple is located, the located tuple is updated based on information included in the message including the publish command.

A relationship manager 302 performs the matching described earlier and establishes the relationships also previously described. In the depicted embodiment, each relationship is stored in the tuple database 312. For example, one or more link tables are created in the database 312, where each record in a link table identifies the records/tuples associated by a relationship represented by the link table record. In this case, a record in a link table is created by the relationship manager 302 for the relationships 224, 230, and 236 depicted by the solid lines of system 200, and described earlier The relationships 204 and 216, depicted by the broken lines in the figure, are established prior to the operation of the corresponding network appliances by, for example, a manufacturer, a reseller, and/or an installer each of which may serve as the “token authority” described above over a particular network domain, and thus enabled to define class identifiers for the particular domain. Rather than or in addition to using a link table, a relationship in some embodiments can be represented by a record/tuple identifier of a first tuple stored in a second record/tuple, thereby creating a relationship between the first and second records/tuples.

At block 106 of the method 100 depicted in FIG. 1, a target network appliance, operable within the network, is determined using the established relationships. The target network appliance belongs to a class of network appliances related to the particular network appliance class identifier. The system 200 of FIG. 2 includes means for determining, using the established relationships, a target network appliance operable within the network belonging to a class of network appliances related to the particular network appliance class identifier. For example, a traversal engine 314 is configured to determine, using the established relationships, a target network appliance, such as first service appliance 208 and/or second service appliance 218, operable within the network, that belongs to a class of network appliances related to the particular network appliance class identifier, for example the “network appliance” class identifier represented by the network client class record 210.

In the exemplary system 200 shown in FIG. 2, the network appliance class record 210 is included in two established relationships: a first relationship 204 with the first service appliance class record 212, and a second relationship 216 with the second service appliance class record 214. When a record is located via a relationship, the remaining relationships of the record, if any, further identify other records that are used depending on the directionality of the relationship and the embodiment. A further identified record may be used to locate a network appliance belonging to a class of network appliances related to the “network appliance” class identifier associated with the received message from the network appliance A 206. Thus, in the system 200, the relationship 224 from the first service appliance class record 212 leads to the first service appliance record 220 that is associated with the first service appliance 208, and the relationship 230 leads to the second service appliance record 226 that is associated with the second service appliance 218.

In the described embodiment, the traversal engine 314 identifies one or more class identifiers associated with a network appliance record when a message is published to an appliance record, such as the network appliance A record 232. A class identifier used by the traversal engine 314 can be included in the message or in the appliance record. The traversal engine 314 uses one or more mapping rules to identify a class record related to the network appliance record by an identified class identifier. The relationship manager 302 in the exemplary system 300, in addition to establishing relationships as already described, is configured to determine what, if any, relationships are associated with a given record. Thus, having identified a class identifier, the traversal engine 314 uses the relationship manager 302 to determine the current relationships of a given record and uses the identified class identifier to determine what, if any relationships, are to be traversed in search of a target for a message from the sending network appliance, e.g., the network appliance A 210 in the current example.

A mapping rule, in the described embodiment, can be used to both identify a class identifier for use and to determine a relationship of a record to traverse. For example, in an exemplary embodiment, a mapping rule is provided that causes the traversal engine 314 to identify all class identifiers associated with a network appliance record, regardless of the source of the class identifiers. In other embodiments, a mapping rule indicates a class identifier comes from a particular source, such as the message, the appliance class record, and/or the appliance record. Based on the class identifiers located by the traversal engine 314 and the relationships of the current record, the traversal engine 314 determines, using the mapping rule, relationships to traverse in search of a next record or a target network appliance. The relationships traversed and their associated records are referred to as “best match” relationships and records. An identified target network appliance is referred to as a “best match” target. A mapping rule may be stored in, or coded into, the traversal engine 314, and/or may be stored in a database, such as the tuple database 312, allowing the rule to be altered as needed. In system 300 at least a portion of the mapping rules are stored in the tuple database 312.

The relationship manager 302, as stated, is used to identify relationships for the traversal engine 314 to consider in applying the mapping rules stored in the tuple database 312 for the purpose of determining one or more “best match” targets. In an embodiment, the relationship router 202 uses all relationships identified by the relationship manager 312 to determine all paths from an appliance class record to a related target network appliance. That is, all paths are “best match” paths. A message from a network appliance can thus be considered a broadcast message.

In other embodiments, the mapping rules identify one or more paths based on information including at least one of the message, the appliance class record, and the appliance record. For example, in one embodiment a message is associated with data that has a multipurpose internet mail extensions (MIME) type included in the message. The MIME type identifies a content type of content to be sent to the target appliance and/or to be output (or presented) by the target appliance. Mapping rules are provided that associate a particular MIME type with a particular service class identifier corresponding to network appliances providing the particular service assigned the service class identifier by a token authority. For example, a message including the MIME type, “text/html,” indicating the type of a portion of the message content, is mapped to a network appliance corresponding to a browser service class identifier by a provided mapping rule. A message including a MIME type identifying the associated content as POSTSCRIPT™ data is associated with a POSTSCRIPT capable printer service class, in the example case.

In another example, mapping rules can be based on a function class identifier of a sending network appliance message and a function class identifier of a target network appliance. For example, consider a message from a sending network appliance associated with a DVR class identifier indicating the network appliance provides DVR capabilities is associated with a target network appliance associated with a display class identifier indicating the target network appliance is a display. The relationships between the class records representing the DVR class identifier and the display class identifier can be specified by at least one of a manufacturer, reseller, and installer of the sending network appliance, the relationship router 202, and/or the target network appliance involved. Other information that is used in some situations in association with a mapping rule includes status information of a network appliance, a service hosted by a network appliance, and/or a resource accessible via a network appliance. Command information is used by some embodiments where the command information is typically included in a message. The examples of information described applicable to mapping rules used by a traversal engine are illustrative and not exhaustive.

The process of determining a target network appliance based on the established relationships is depicted in message flow diagram 400 of FIG. 4 as a message 404 to apply the mapping rules retrieved from the database 312 by traversal engine 314.

At block 108 of the method 100 depicted in FIG. 1, the received message is routed to the target network appliance via the network. In an exemplary embodiment, the system 300 includes means for routing the received message to the determined target network appliance via the network. For example, in the system 300, the message router 304 is configured to route the received message to the determined target network appliance via the network. For example, in the system 200 in the embodiment where all paths from a sending network appliance record, such as network appliance A record 232, are considered “best match” paths, all corresponding targets are identified as “best match” targets. The message is, thus, sent to all target network appliances located by the traversal engine 314. In this case, when network appliance A 206 sends a message to the relationship router 202, the traversal engine 314 identifies both the first service appliance 208 and the second service appliance 218 by following all relationships paths starting from the network appliance A record 232. In an embodiment where the relation router is based on a publish-subscribe or presence service, the traversal engine 314 causes a notification handler 316 to create a notification based on the received message for each of the first service appliance 208 and the second service appliance 218. The notification handler 316 sends the notifications to the two services via the message router 304, the presence protocol layer 308, and the network stack 306 over the network (not shown).

In an exemplary embodiment, the target network appliance includes a presentation capability via a display or an audio subsystem, for example. With such an arrangement, the received message can include presentation information for presenting information by the target network appliance. The message can include content type information and a function class identifier associated with visual and/or audio presentations. The relationship router can further determine a best match network appliance based on a mapping rule that uses the content type information and the function class identifier to locate a network appliance record capable, or best suited, for presenting the message content. In the message flow diagram 400, the message is shown as a notify message 406, where the first service appliance 208 is a best match network appliance capable of presenting the message content.

Each target network appliance determines how to process the message based on information included in the message, such as a content type, a command, and/or an attribute of the network appliance. Attributes can include the current state, status, mode, and/or security constraints of the network appliance. Processing, in some cases, involves processing at least a portion of the message content only. The processing described is shown as a message 408 to process the message 402 in the message flow diagram 400 of FIG. 4.

In an alternate embodiment, the message sent to the target network appliance is for establishing communication between the sending network appliance and the target network appliance. For example, the message in some embodiments includes a network address of the sending network appliance, allowing the target network appliance to send a message to the sending network appliance via the network to establish a connection between the two network appliances. In an alternate embodiment, the message includes an address of a proxy with which the target network appliance establishes communication, enabling the target to receive messages from the sending network appliance. For example, a notification from the relationship router based on a publish-subscribe service may provide an identifier of a tuple. The target network appliance subscribes to the tuple allowing target appliance to receive a message from a sending network appliance that publishes information to the tuple. Alternately, communication may be setup through message queue systems, IM systems, and email, file transfer protocol (FTP), and remote procedure call (RPC) services, to name just a few examples.

As described above, other mapping rules can cause the traversal engine 314 to identify a subset of the services for which a path exists from the network appliance record of the sending appliance to all best match target network appliance records connected by a path of relationships.

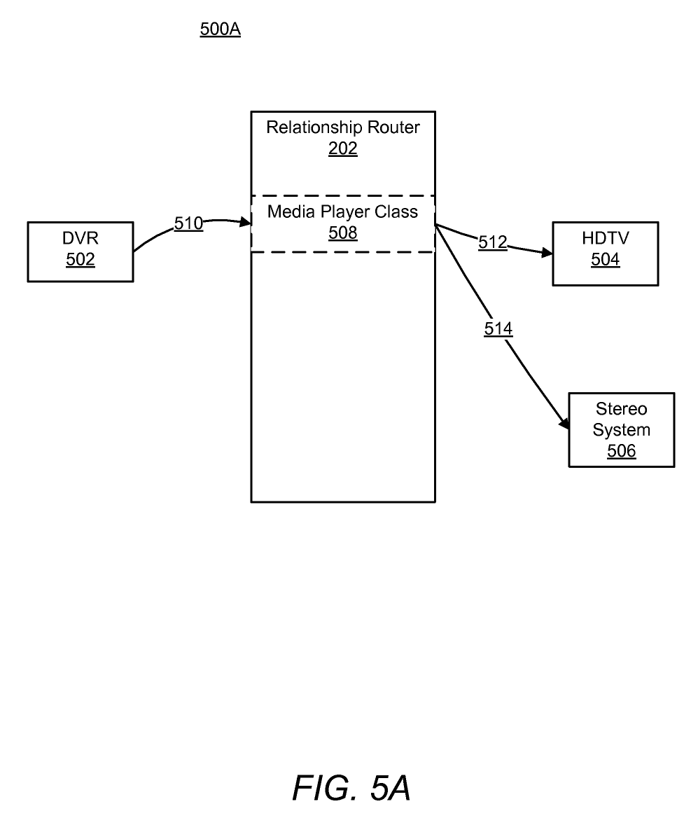

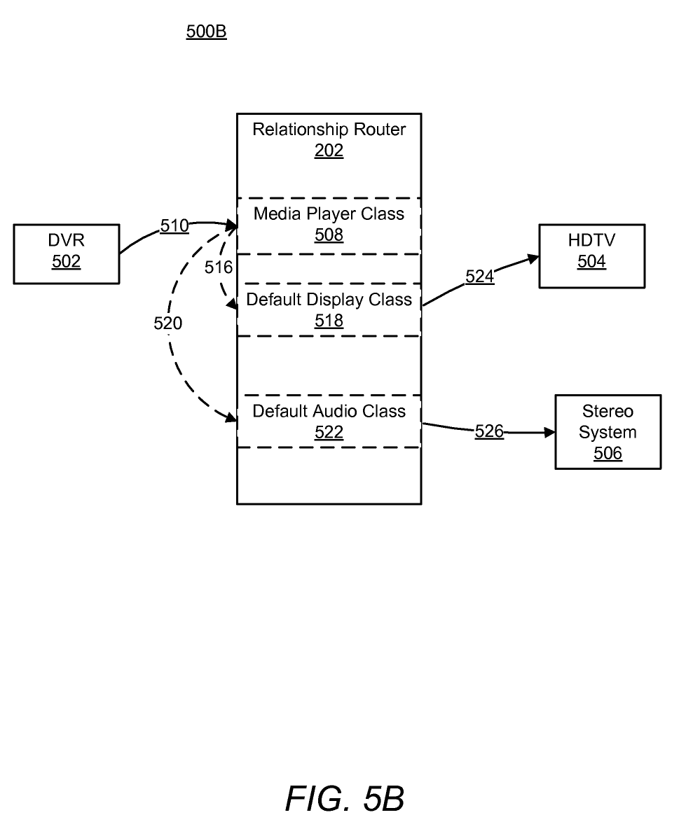

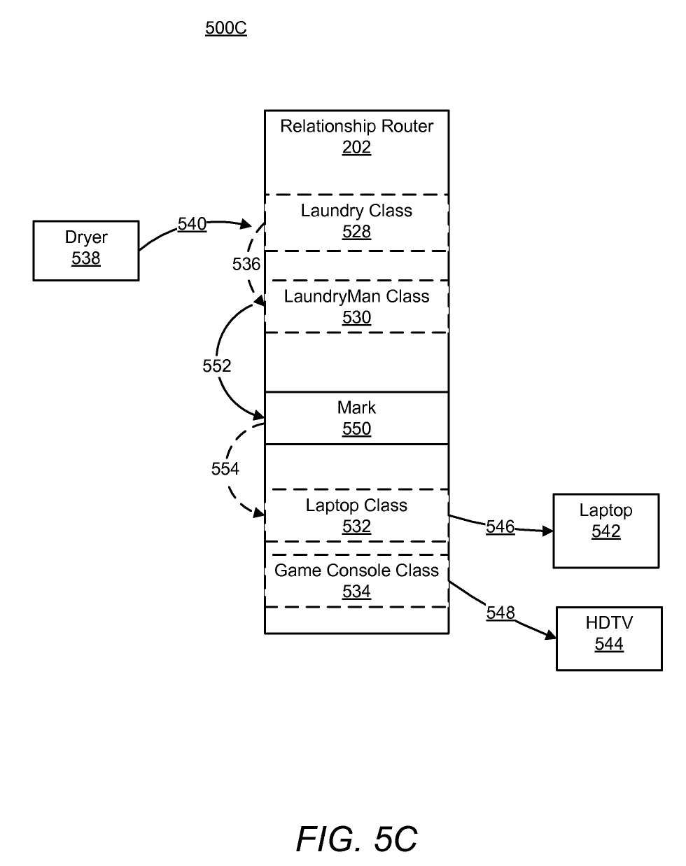

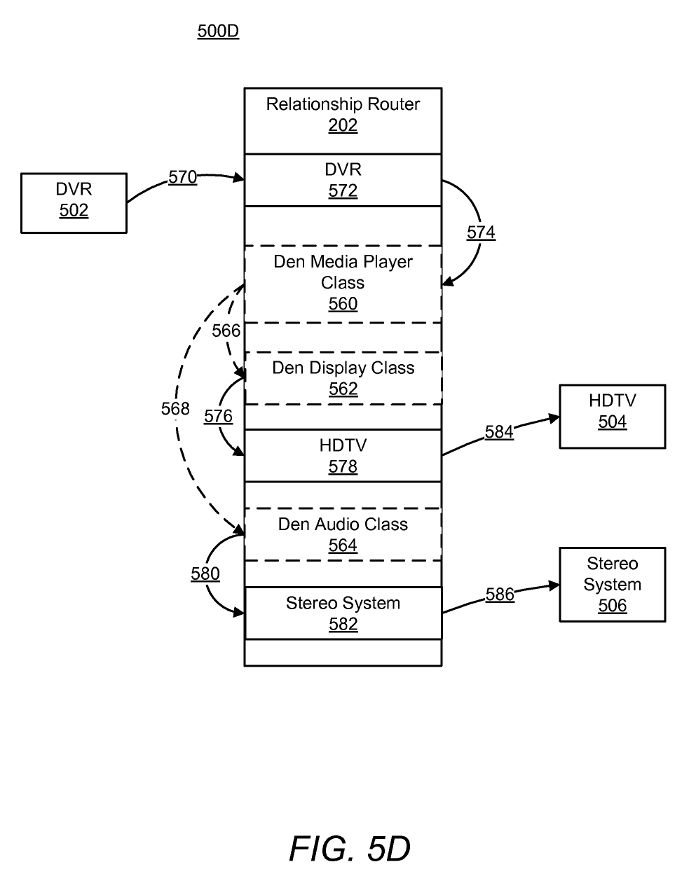

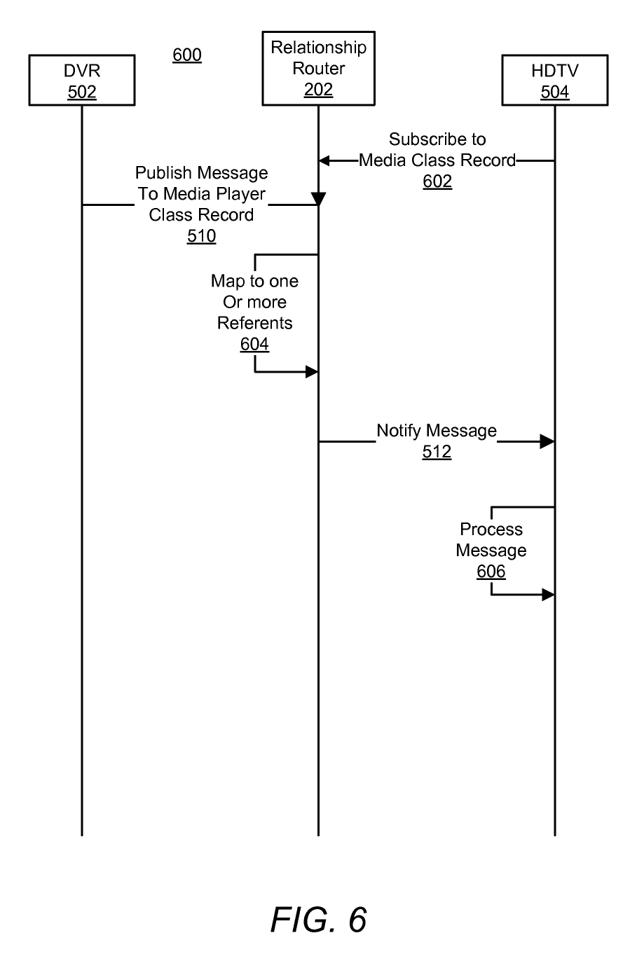

FIG. 5A depicts system 500A, an alternate system for carrying out the method 100 of FIG. 1, where the relationship router 202 need not maintain records for the various network appliances depicted in the system 500, e.g., a DVR 502, an HDTV 504, and a stereo system 506. The relationship router 202 maintains only class records associated with class identifiers. System 500 depicts a pre-established media player class record 508 associated with a “media player” class identifier, representing all network appliances capable of processing, in preparation for presentation, one or more forms of media, such as video, audio, and still image data. Each of the DVR 502, the HDTV 504, and the stereo system 506 is preconfigured with the “media player” class identifier of the media player class record 508 by, for example, a manufacturer, reseller, and/or installer of the respective appliances. In the embodiment, network appliances that provide services usable by a network appliance of the “media player” class subscribe to events associated with the media player class record 508 using the “media player” class identifier assigned. Thus, the HDTV 504 and the stereo system 506 each may have subscriptions associated with the media player class record 508. A message subscribing to the media player class record 508 is shown as message 602 in the message flow diagram 600 depicted in FIG. 6.

When, for example, the DVR 502 enters play mode, the DVR 502 sends a message 510, such as a publish message, over a network (not shown) including the preconfigured “media player” class identifier of the media player class record 508 to the relationship router 202. The message 510 is also depicted in the message flow diagram 600 in FIG. 6. Based on information in the message, the traversal engine 314, in the embodiment supporting the system 500A, identifies both the HDTV 504 and the stereo system 506 as target network appliances as a result of, at least in part, their previous subscriptions to the media player class record 508. For example, the message 510 from the DVR 502 can include MIME type information indicating the DVR 502 has both video content and audio content to play. This is depicted as a message 604, sent and received within the relationship router 202, in the message flow diagram 600 of FIG. 6 sent to the traversal engine 314 for identifying the related target network appliances.

An event or notification is generated based on the message 510, for example, by a subscription handler 318 invoking the notification handler 316 in the case of the presence-based embodiment of relationship router 202 described in conjunction with the system 300. Events or notifications are sent over the network to the identified target network appliances including at least a portion of the subscribers to the media player class record 508 providing the needed services indicated by the MIME type information included in the message 510. A notification 512 is sent to the HDTV 504 shown in both the system 500A and message flow diagram 600, and a notification 514 is sent to the stereo system 506 shown in the system 500A, where the notifications 512 514 are based on the message 510. In one embodiment, this operation establishes a path through the relationship router 202 through which the content from the DVR 502 is routed.

In another embodiment, the message 510 includes network address information for the DVR 502 allowing the HDTV 504 and the stereo system 506 to establish communications directly over the network (not shown) with the DVR 502 allowing, for example, the playing of a video stream by the HDTV 504 and/or an audio stream by the stereo system 506 without passing the streams through the relationship router 202. The DVR 502 may synchronize the two media streams based on information provided by the two target network appliances. At least one of the HDTV 504 and the stereo system 506 is enabled to locate the other to establish communication between the HDTV 504 and the stereo system 506, allowing the two appliances to synchronize the playing of the video and audio streams. The processing of the notification 512 by the HDTV 504 is shown as a message 606 to process the notification 512 in the message flow diagram 600 of FIG. 6.

In an alternate embodiment, the relationship router 202 in the exemplary system 500B shown in FIG. 5B is preconfigured with a set of class records known to the providers and/or administrator of the HDTV 504 and the stereo system 506. The relationship router 202 also includes pre-established relationships, such as a relationship 516 between the media class player record 508, and a default display class record 518 whose class identifier is known to the HDTV 504. Using the “default display” class identifier, the HDTV 504 can be subscribed to notifications associated with the default display class record 518 maintained by the relationship router 202. Using these relationships, the traversal engine 314 is capable of relating the HDTV 504 to a class record, such as the media class player record 508, without the HDTV 504 knowing the class identifier of the media class player record 508. Analogously, in the example, the relationship router 202 also includes a pre-established relationship 520 between the media class player record 508 and a default audio class record 522 associated with a “default audio” class identifier known to the stereo system 506. As with the HDTV 504, the default audio class record 520 enables the stereo system 506 to be related to the DVR 502 via the media player class record 508 without requiring the stereo system 506 to have any knowledge of the “media player” class identifier via a subscription established by the stereo system 506 with the relationship router 202 using the “default audio” class identifier. A notification is, or notifications 524 526 are, routed to one, or both, of the HDTV 504 and stereo system 506 in a manner analogous to the manner previously described using only the media class player record 508 when a message, such as the message 510 from the DVR 502 associated with the “media player” class identifier, is received by the relationship router 202.

According to another exemplary embodiment, additional relationships can be established between the plurality of network appliances and a plurality of network appliance users. The target network appliance can be determined using both the particular network appliance class identifier and an established relationship between the target network appliance and a particular network appliance user.

For example, FIG. 5C depicts an exemplary system 500C including the relationship router 202 that employs user class identifiers and user role or group class identifiers along with network appliance function class identifiers. The relationship router 202 in the exemplary embodiment includes a laundry class record 528 associated with a function class identifier for laundry activities, a laundryman class record 530 associated with a role class identifier for a person involved in laundry activities, a laptop class record 532 associated with a function class identifier for general computing, and a game console class record 534 associated with a function class identifier for game consoles. Also depicted is a relationship 536 between the laundry class record 528 and the laundryman class record 530. A dryer 538 is assigned the “laundry” class identifier for sending a message 540 to the relationship router 202 that the relationship router associates with the laundry class record 528 based on the “laundry” class identifier. If supported by the dryer 538, the dryer 538 may subscribe to the laundry class record 528 allowing the dryer to be located and sent messages.

Also depicted in the exemplary system 500C is a laptop 542 assigned the “laptop” class identifier and a game console 544 assigned the “game console” class identifier. The laptop 542 uses the “laptop” class identifier to send messages to the relationship router 202 that starts a path traversal for a best match target appliance at the laptop class record based on the matching class identifier. Like the dryer 538, the laptop 542 uses the “laptop” class identifier to establish a subscription with the relationship router 202 for receiving messages, such as a message 546, where the laptop class record 532 is the endpoint record of a path traversal identifying the laptop 542 as a best match target. Analogously, the game console 544 uses its assigned “game console” class identifier to send messages via the game console record class 534 and receive messages, such as message 548, based on a subscription associated with the game console class record 534 based on the “game console” class identifier. All the records and relationships just discussed are enabled by the establishing of the records and relationships illustrated with broken lines already discussed prior to operation within the network environment of the discussed network appliances.

The system 500C, notwithstanding the established relationships, does not yet allow the dryer 538 to send a message to a target network appliance. In the example, a user record is added, depicted as a “Mark” record 550, by a user configuring the relationship router 202. In the example, Mark can be a person in a house including the network that is responsible for the laundry. That is, Mark is a laundryman. As a result the relationship router is instructed to establish a relationship 552 between the laundryman class record 530 and the Mark record 550 directly, or the Mark record 552 includes the “laundryman” class identifier allowing the relationship router 202 to automatically establish the relationship 552.

When the message 540 including the laundry class record identifier is received by the relationship router 202 from the dryer 538, the traversal engine 314, using the established relationships, detects the Mark record 550 in the traversal of a best match path. In a related embodiment, routing of a message is performed by further determining whether a particular network appliance user is using the sending and/or target network appliances. For example, the relationship router 202 described in conjunction with the system 300 can use the presence service (not shown), operatively coupled to the plurality of network appliances via the network, to determine a particular network appliance a user is using. If Mark is not in communication with a network appliance, e.g., as determined using the presence service, the relationship router 202 may be unable to determine a best match network appliance for message delivery. Some embodiments may include default best match “appliances” such as a house intercom or lighting system to at least indicate to Mark that a message for him is waiting to be delivered. For example, the lights throughout the house may flash quickly three times as a signal specifically to Mark. If Mark is logged onto the laptop 542, the laptop, in the embodiment, sends an update message to the relationship router including the “laptop” class identifier and an identifier for Mark. Mark is in a class by himself.

The relationship router 202, using the two class identifiers, matches the Mark class identifier with the Mark record 550 and the laptop class record 532 with the “laptop” class identifier. As a result, the relationship router dynamically establishes a relationship 554 between the Mark record and the laptop class record. Thus, if the message 540 received from the dryer 538 is received when Mark is logged into the laptop 542, the traversal engine 314 locates a path from the laundry class record 528 through the laundryman class record 530 to the Mark record 550 based on the established relationships 536, 552. Additionally, the traversal engine is allowed to use the established relationship 554 from the Mark record 550 to the laptop class record 532 locating a best match record. Using the subscription list of the laptop class record 532, the relationship manager routes a message 546 to the laptop 542, where the message 546 can be received by Mark.

One skilled in the art can see that multiple records associated with user class identifiers and/or user roles can be established. Further relationships can be established among or between user records and/or user role records. Relationships can be established among or between user records, user role records, class records, and network appliance records for both sending and target appliances. At least a portion of these records and relationships may be established by a manufacturer, installer, reseller, and/or other token authority. Thus, a first user associated with a sending network appliance can send a message to a second user associated with a target network appliance based on the established relationships and records of a relationship router and mapping rules used by the relationship routers traversal engine.

In yet another exemplary embodiment, additional relationships can be established between the plurality of network appliances and a plurality of network appliance locations. The target network appliance can be determined using both the particular network appliance class identifier and an established relationship between the target network appliance and a particular network appliance location.

For example, relationship router 202 can be configured to use location information in determining a best match target network appliance by the traversal engine 314. In one embodiment, network appliance records include location information configured by a user, provided by the network appliance to the relationship router 202, or determined by another appliance or system, such as a network switch (not shown) configured with the location information associated with each of its network ports. Location information may be included in a message from a sending network appliance and used by the traversal engine 314 in determining a best match target network appliance as supported by a mapping rule.

In a further embodiment depicted in the exemplary system 500D shown in FIG. 5D, location class identifiers are supported enabling the use of location class records in creating relationships with network appliances associated with a location corresponding to the location class identifier of one of the location class records. In the system 500D, a den media player class record 560, a den display class record 562, and a den audio class record 564 are established in the relationship router 202, each associated with corresponding identifiers. A relationship 566 between the den media play class record 560 and the den display class record 562 is established. Additionally, a relationship 568 between the den media play class record 560 and the den audio class record 564 is established. The situation is similar to that depicted in the system 500A except the class records include a location class identifier associated with a den room in a house. The DVR sends messages, such as a message 570, including the DVR class identifier and a media class player identifier. A DVR record 572 is created or updated by the relationship router 202. In one embodiment, a user provides the DVR with a “den” class identifier that is also included in the message 570. Alternatively, the DVR may receive its location class identifier via a network switch as previously described or, perhaps, via the power line system of the house functioning as a network medium.

Using the “media player” class identifier and the “den” class identifier, the relationship router 202 automatically establishes the relationship 574 between the DVR record 572 and the media class player record 560. In another embodiment, a location class identifier and a function class identifier of the media player class are not included in the message 570. In this embodiment, a user interface is provided allowing a user to explicitly create the relationship 574 between the two records. In an analogous manner, the HDTV 504 and the stereo system 506 register with the relationship router 202 resulting in the establishing of a relationship 576 between the den display class record 562 and the HDTV record 578, and the establishing of a relationship 580 between the den audio class 564 and the stereo system record 582. Thus, the three depicted network appliances in the den are related to each other via relationship paths in the relationship router. When the DVR 502 enters play mode, for example, and sends the message 570 received by the relationship router 202, the relationship router 202, via its traversal engine 314, is configured to determine that the HDTV record 578 and the stereo system record 582 are best match records. The relationship router 202 then sends a message 584 to the HDTV 504 based on information in the HDTV record 578, and also sends a message 586 to the stereo system 506 based on information in the stereo system record 582. In this manner, messages are routed from the dryer 502 to both the HDTV 504 and stereo system 506 using network appliance class identifiers and established relationships.

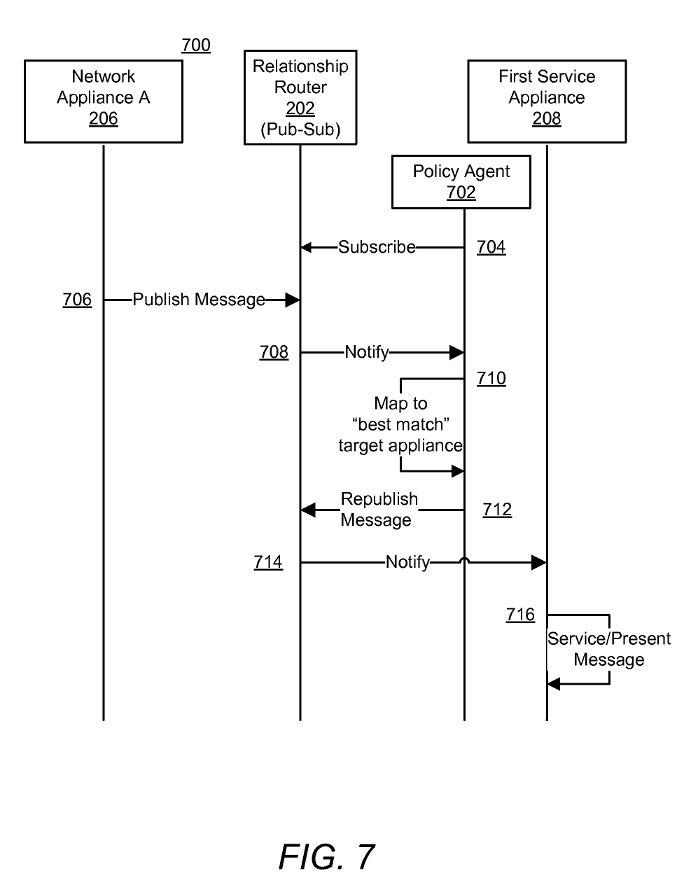

In an alternate embodiment, a message flow where mapping rules are enforced by one or more separate policy agents is depicted in the message flow diagram 700 shown in FIG. 7. This arrangement is semi-distributed. One can see that pure peer-to-peer embodiments can exist where at least one of the appliances enforces at least a portion of the mapping rules for the network appliances on the network. In the message flow 700, a policy agent 702 subscribes or polls a relationship router 202 for notification of all or a specified portion of messages received by the relationship router 202 as depicted by a message 704. When a message depicted as a publish message 706 is received by the relationship router from the network appliance A 206, a notification 708 is sent to the policy agent 702. The policy agent can include mapping rules and a traversal engine for the set of network appliances watched by the policy agent. The policy agent 702, using the mapping rules and traversal engine, determines a best match target network appliance using established relationships maintained by the relationship router 202 and/or the policy agent 702 depicted as message 710 in the flow diagram. The policy agent 702 sends a message 712, effectively republishing the message 706, from the network appliance A 206. The message 712 indicates one or more network appliances that should receive a message based on the message from the network appliance A. In FIG. 7, the first service appliance 208 is sent a notify message 714. The first service appliance 208 processes the message as depicted by a message 716 to itself.

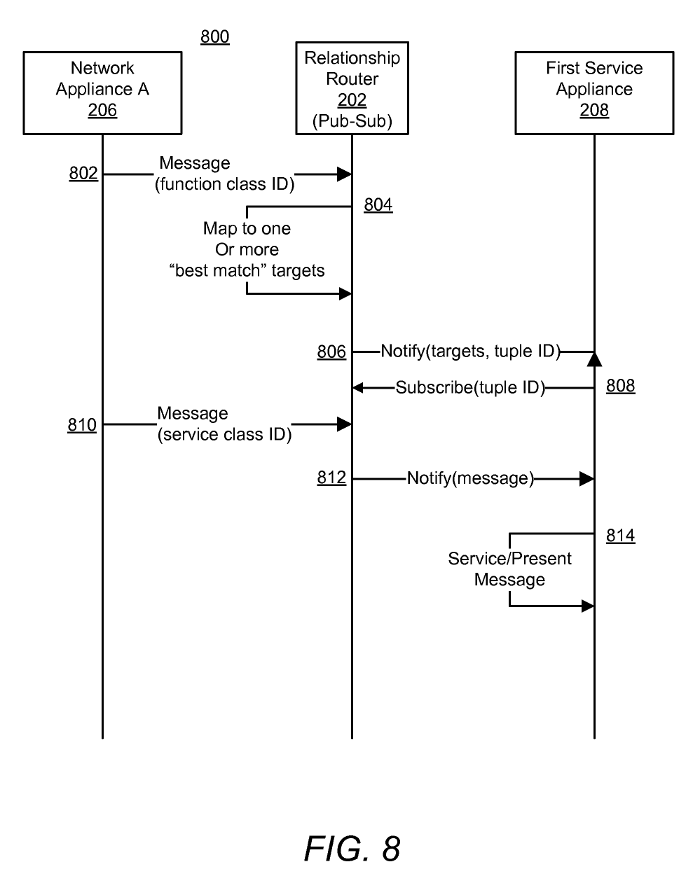

In yet another embodiment depicted in a message flow 800 shown in FIG. 8, rather than sending a message and having it routed dynamically by the relationship router 202, a network appliance, such as the network appliance A 206, sends a message 802 to the relationship router 202. The message includes a class identifier that, for purposes of illustration, is a function class identifier identifying a function of the network appliance A 206. The relationship router 202 creates a record for the network appliance A 206 as described in conjunction with previous examples. The relationship router 202, using its traversal engine 314 determines all possible best match network appliances based on the established relationships existing at the time, depicted as a message 804 sent to itself. In one embodiment, the relationship router 202 sends a message 806 including an identifier of the record of the sending network appliance to each best match target network appliance determined, such as the first service appliance 208. The best match target network appliances, such as the first service appliance 208, may then be subscribed via a request 808 to the tuple of the sending network appliance, network appliance A 206. This effectively sets up a route from the sending network appliance, network appliance A 206, to each of its best match target network appliances, such as the first service appliance 208. For example, consider that network appliance A 206 sends a message 810 including a service class identifier to the relationship router 202. The relationship router's 202 traversal engine 314 scans the subscription list of the network appliance A record 232 for subscribers with a matching service class identifier. If the first service appliance's 208 subscription includes a matching service class identifier, a message 812 based on the received message 810 is sent to the first service appliance 208. First service appliance 208 processes the message as shown in action 814 of the flow diagram 800.

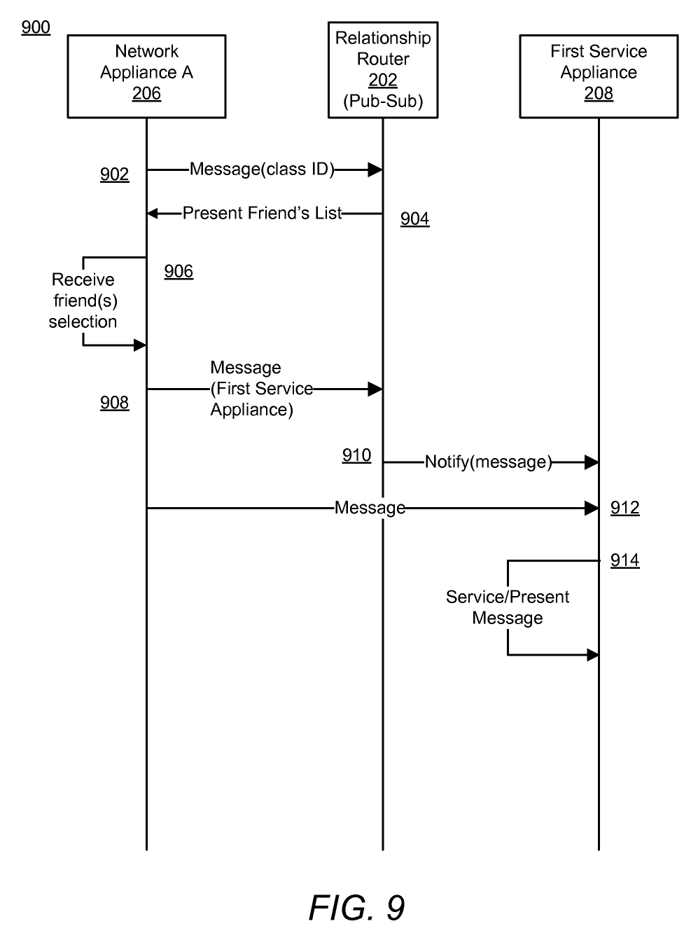

In a further embodiment, similar to the message flow 800 shown in FIG. 8, a message flow 900 shown in FIG. 9 depicts a network appliance, such as the network appliance A 206, that sends a message 902 to the relationship router 202. The message includes a class identifier of a particular type, such as a function class identifier that identifies a function of the network appliance A 206. The relationship router 202 creates a record for the network appliance A 206 as described in previous examples. The relationship router 202 may using its traversal engine 314 to determine the possible best match network appliances based on the established relationships at existing at the time, as described in conjunction with the message flow 800 depicted in FIG. 8.

Alternately or additionally, a friends list can be established for the network appliance A record 232. The relationship router sends the friends list in a message 904 including configured network appliances and/or best match network appliances to the sending appliance, such as network appliance A 206. Each entry in the list can include the relationship router identifier of the associated network appliance and/or a network address identifier of the associated network appliance. The network appliance A 206 stores the friends list depicted by the message 906 to itself. When needed, the network appliance A 206, using a class identifier known to the network appliance A 206, determines a best match target network appliance using the class identifiers in the entries of the friends list. Once a best match network appliance, such as the first service appliance 208 is determined, a message 908 is sent via the relationship router using identifier of the target network appliance available via the relationship router 202. The relationship router 202, using the identifier, is enabled to send a message 910 based on the received message to the target network appliance, first service appliance 208. In an alternate embodiment, the sending network appliance, network appliance A 206, uses a network address identifier included in the friends list entry of a best match target network appliance. The sending network appliance, network appliance A 206, is thus configured to send a message 912 directly to the target network appliance, first service appliance 208. When the message 912 is received by the target network appliance, first service appliance 208, the message is processed, as depicted in action 914.

A variation of the embodiment supporting the message flow 900 enables the network appliance A 206 acting in the role of a target network appliance to receive a friends list that includes entries of possible sending network appliances based on user configuration and path traversal searching, identifying best match network appliances.

The executable instructions of a computer program for carrying out the methods illustrated in FIG. 1 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

As one skilled in the art can see, there are many possible message flows in routing a message over a network. An embodiment where the information is routed through the relationship router has been shown; embodiments where the appliance may send the message directly or through a proxy have been described as alternatives. Classes of embodiments allowing a service to request the information from a proxy, the relationship router, or directly from an appliance also exists and flows supporting these classes of embodiments can be generated by one skilled in the art provided with the description given. Further, one skilled in the art can see the methods, systems, and program products described are capable of dynamic adjustment as messages are received and routed where the appearance of new network appliances, changes to network appliance attributes, changes in users of a system, changes in location of a user or a network appliance all affect the records maintained, the established relationships, and thus the determination of “best match” network appliances.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for routing a message over a network, the method comprising:
establishing relationships among a plurality of network appliances using respective network appliance class identifiers assigned to the appliances, wherein the respective network appliance class identifiers are assigned to identify corresponding classes of network appliances prior to their operation within the network environment;
receiving a message over the network from a sending network appliance, the message including a particular network appliance class identifier;
determining, using the established relationships, a target network appliance operable within the network belonging to a class of network appliances related to the particular network appliance class identifier; and
routing the received message to the target network appliance via the network.

2. The method of claim 1, wherein the particular network appliance class identifier identifies a class of the sending networking appliance.

3. The method of claim 1, wherein the particular network appliance class identifier identifies a class of the target networking appliance.

4. The method of claim 1, comprising:
establishing additional relationships between the plurality of network appliances and a plurality of network appliance users, wherein the target network appliance is determined using both the particular network appliance class identifier and an established relationship between the target network appliance and a particular network appliance user.

5. The method of claim 4, wherein determining the target network appliance comprises:
determining the particular network appliance user is using at least one of the sending and target network appliances.

6. The method of claim 5, wherein determining the target network appliance comprises:
using a presence service, operatively coupled to the plurality of network appliances via the network, to determine the particular network appliance user is using at least one of the sending and target network appliances.

7. The method of claim 4, comprising:
using respective network appliance user identifiers assigned to the network appliance users for establishing the additional relationships between the plurality of network appliances and the plurality of network appliance users; and
using a particular network appliance user identifier included in the message to determine the particular network appliance user;
wherein the target network appliance is determined using both the particular network appliance class and user identifiers.

8. The method of claim 7, wherein the particular network appliance user identifier is assigned to the particular network appliance user or another network appliance user, and when the particular network appliance user identifier is assigned to another network appliance user, determining the target network appliance comprises:
determining the other network appliance user is associated with the particular network appliance user allowing use of the particular network appliance user identifier in determining the target network appliance device.

9. The method of claim 7, wherein the particular network appliance user identifier identifies a user role and determining the target network appliance comprises:
determining the particular network appliance user is related to the identified user role, allowing use of the particular network appliance user identifier in determining the target network appliance device.

10. The method of claim 1, comprising:
establishing additional relationships between the plurality of network appliances and a plurality of network appliance locations, wherein the target network appliance is determined using both the particular network appliance class identifier and an established relationship between the target network appliance and a particular network appliance location.

11. The method of claim 10, wherein determining the target network appliance comprises:
determining at least one of the sending and target network appliances is located within a predetermined proximity of the particular network appliance location.

12. The method of claim 10, comprising:
using respective network appliance location identifiers assigned to the network appliance locations for establishing the additional relationships between the plurality of network appliances and the plurality of network appliance locations; and
using a particular network appliance location identifier included in the message to determine the particular network appliance location;
wherein the target network appliance is determined using both the particular network appliance class and location identifiers.

13. The method of claim 12, wherein the particular network appliance location identifier is assigned to the particular network appliance location or another network appliance location, and when the particular network appliance location identifier is assigned to another network appliance location, determining the target network appliance comprises:
determining the other network appliance location is associated with the particular network appliance location.

14. The method of claim 7, wherein the particular network appliance location identifier identifies a location role and determining the target network appliance comprises:
determining the particular network appliance location is related to the identified location role.

15. The method of claim 1, wherein determining the target network appliance comprises:
using at least one of a content type identifier, a command identifier, and an attribute of a service provided by at least one of the sending and target network appliances included in the message to determine the target network appliance.

16. The method of claim 1 wherein the message includes presentation information for presentation by the target network appliance.

17. The method of claim 1 wherein the particular network appliance class identifier is included in a uniform resource locator (URL) destination identifier for the message.

18. The method of claim 1 wherein establishing relationships among a plurality of network appliances using respective network appliance class identifiers assigned to the appliances to identify corresponding classes of network appliances prior to their operation within the network environment comprises:
pre-associating the network appliance class identifiers with the corresponding classes of network appliances in connection with at least one of manufacturing, installation, and sale of the classes of network appliances.

19. The method of claim 1 wherein a particular network appliance class is identified by a token defined by a token authority.

20. A system for routing a message over a network, the system comprising:
a relationship manager configured to establish relationships among a plurality of network appliances using respective network appliance class identifiers assigned to the appliances, wherein the respective network appliance class identifiers are assigned to identify corresponding classes of network appliances prior to their operation within the network environment;
a message router configured to receive a message over the network from a sending network appliance, the message including a particular network appliance class identifier; and
a traversal engine configured to determine, using the established relationships, a target network appliance operable within the network belonging to a class of network appliances related to the particular network appliance class identifier;
wherein the message router is configured to route the received message to the target network appliance via the network.

21. The system of claim 20, wherein the relationship manager is configured to establish additional relationships between the plurality of network appliances and a plurality of network appliance users and the traversal engine is configured to determine the target network appliance using both the particular network appliance class identifier and an established relationship between the target network appliance and a particular network appliance user.

22. The system of claim 20, comprising:
a presence service client, operatively coupled to the traversal engine, the presence service client configured to exchange presence information with a presence service, operatively coupled to the plurality of network appliances via the network, to determine the particular network appliance user is using at least one of the sending and target network appliances.
wherein the traversal engine is configured to use the presence information to determine the target network appliance.

23. The system of claim 20, wherein the relationship manager is configured to use respective network appliance user identifiers assigned to the network appliance users for establishing the additional relationships between the plurality of network appliances and the plurality of network appliance users and the traversal engine is configured to use a particular network appliance user identifier included in the message to determine the particular network appliance user and to determine the target network appliance using both the particular network appliance class and user identifiers.

24. The system of claim 23, wherein the particular network appliance user identifier is assigned to the particular network appliance user or another network appliance user, and when the particular network appliance user identifier is assigned to another network appliance user, the relationship manager is configured to determine the other network appliance user is associated with the particular network appliance user, allowing the traversal engine to use the particular network appliance identifier to determine the target network appliance.

25. The system of claim 23, wherein the particular network appliance user identifier identifies a user role and the relationship manager is configured to determine the particular network appliance user is related to the identified user role, allowing the traversal engine to use the particular network appliance identifier to determine the target network appliance.

26. The system of claim 20, wherein the relationship manager is configured to establish additional relationships between the plurality of network appliances and a plurality of network appliance locations, wherein the target network appliance is determined using both the particular network appliance class identifier and an established relationship between the target network appliance and a particular network appliance location.

27. The system of claim 20, wherein in determining the target network appliance the traversal engine is configured to determine at least one of the sending and target network appliances is located within a predetermined proximity of the particular network appliance location.

28. The system of claim 20, wherein the relationship manager is configured to use respective network appliance location identifiers assigned to the network appliance locations for establishing the additional relationships between the plurality of network appliances and the plurality of network appliance locations and the traversal engine is configured to use a particular network appliance location identifier included in the message to determine the particular network appliance location and to determine the target network appliance using both the particular network appliance class and location identifiers.

29. The system of claim 28, wherein the particular network appliance location identifier is assigned to the particular network appliance location or another network appliance location, and when the particular network appliance location identifier is assigned to another network appliance location, the relationship manager is configured to determine the other network appliance location is associated with the particular network appliance location, allowing the traversal engine to use the particular network appliance identifier to determine the target network appliance.

30. The system of claim 28, wherein the particular network appliance location identifier identifies a location role and the relationship manager is configured to determine the particular network appliance location is related to the identified location role, allowing the traversal engine to use the particular network appliance identifier to determine the target network appliance.

31. The system of claim 20, wherein the relationship manager is configured to use at least one of a content type identifier, a command identifier, and an attribute of a service provided by at least one of the sending and target network appliances included in the message to determine the target network appliance.

32. The system of claim 20 wherein the message includes presentation information for presentation by the target network appliance.

33. The system of claim 12 wherein the particular network appliance class identifier is included in a uniform resource locator (URL) destination identifier for the message.

34. A system for routing a message over a network, the system comprising:
means for establishing relationships among a plurality of network appliances using respective network appliance class identifiers assigned to the appliances, wherein the respective network appliance class identifiers are assigned to identify corresponding classes of network appliances prior to their operation within the network environment;
means for receiving a message over the network from a sending network appliance, the message including a particular network appliance class identifier;
means for determining, using the established relationships, a target network appliance operable within the network belonging to a class of network appliances related to the particular network appliance class identifier; and
means for routing the received message to the target network appliance via the network.

35. A computer readable medium containing a computer program for routing a message over a network, the computer program comprising executable instructions for:
establishing relationships among a plurality of network appliances using respective network appliance class identifiers assigned to the appliances, wherein the respective network appliance class identifiers are assigned to identify corresponding classes of network appliances prior to their operation within the network environment;
receiving a message over the network from a sending network appliance, the message including a particular network appliance class identifier;
determining, using the established relationships, a target network appliance operable within the network belonging to a class of network appliances related to the particular network appliance class identifier; and
routing the received message to the determined target network appliance via the network.

36. A method for routing a message over a network, the method comprising:
generating a message including a particular network appliance class identifier assigned to a sending network appliance prior to operation of the sending network appliance within the network environment; and
having the generated message processed using a set of relationships established among a plurality of network appliances, including the sending network appliance, to determine a target network appliance, operable within the network, belonging to a class of network appliances related to the particular network appliance class identifier included in the generated message and to route the message to the target network appliance via the network;
wherein the set of relationships is established using respective network appliance class identifiers assigned to the network appliances to identify corresponding classes of network appliances prior to their operation within the network environment.

37. The method of claim 36, wherein the particular class identifier identifies a class of network appliances providing at least one of a first service provided by the sending network appliance and a second service that the target network appliance requires or is capable of processing.

38. The method of claim 36, wherein the set of relationships is managed by at least one of the sending network appliance, the target network appliance, and a routing device, other than the sending and target network appliances, coupled to the plurality of network appliances via the network.

39. The method of claim 38, wherein having the generated message processed comprises locating the routing device configured to manage the set of relationships among the plurality of network appliances by at least one of:
using a service record stored in a domain name service (DNS) to identify a network address of the routing device;
listening for a broadcast message including the network address of the routing device sent to the plurality of network appliances via the network; and
receiving the network address from a dynamic host configuration protocol (DHCP) server in response to a request sent to the DHCP server by the sending network appliance.
